(19) United States
(12) Patent Application Publication
(10) Pub. No.: US 2006/0158092 A1
(43) Pub. Date: Jul. 20, 2006

(54) High-Pressure Discharge Lamp

(75) Inventor: Changlong Ning, AA Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/538,107

(22) PCT Filed: Nov. 14, 2003
(86) PCT No.: PCT/IB03/05224

§ 371 Date: Jun. 8, 2005

(30) Foreign Application Priority Data
Dec. 13, 2002 (EP) 02080270.8

(51) Int. Cl. H01J 63/04

(52) U.S. Cl. 313/491

(57) ABSTRACT

High-pressure mercury vapor discharge lamp (1) comprising a lamp vessel (2) made of a transparent ceramic material, enclosing a discharge space (3) comprising an ionizable discharge medium and at least two electrodes (4,5), each provided with an electrode tip (4a,5a), which tips are spaced apart at a mutual distance d, and electrical feed-through elements (6,7) which extend from the electrodes (4,5) to the exterior, wherein the distance d between the electrode tips (4a,5a) is less than 1.0 mm and the mercury density in the vessel (2) is higher than 0.3 mg/mm³.

The present invention relates to a high-pressure discharge lamp, comprising a lamp vessel made of a transparent ceramic material, enclosing a discharge space comprising an ionizable discharge medium and at least two electrodes, each provided with an electrode tip, which are spaced apart at a mutual distance d, and electrical lead-through elements which extend from the electrodes to the exterior.

A high-pressure discharge lamps of the type as described above is known from, for example, U.S. Pat. No. 6,307,321. Drawbacks of these known lamps are that the required distance between the electrode tips in the discharge space generally limits the efficacy of the known lamps in projection applications.

It is an object of the invention to provide a small high-pressure mercury vapor discharge lamp which approximates a point light source and which is very useful, for example, for applications such as data/TV projection.

This is achieved by the present invention by providing a high-pressure discharge lamp of the kind mentioned in the opening paragraph, wherein the distance d between the electrode tips is less than 1.0 mm and the mercury density in the vessel is higher than 0.3 mg/mm³. Preferably, in relation with the mentioned mercury density range, the mercury vapor pressure during operation is higher than 35 Mpa (350 bar). According to the present invention it has surprisingly been found that, by using a ceramic material for the lamp vessel, for example yttrium aluminum garnet (YAG), mercury vapor pressures of over 35 Mpa (350 bar) can be achieved during operation, as a result of which the distance between the electrode tips can be significantly reduced while maintaining the same lamp voltage.

According to the present invention, it has been found that the red part of the emitted light spectrum is significantly increased at a working pressure of over 35 Mpa (350 bar). In addition, the lamp according to the invention approximates a point light source as a consequence of the very small distance between the electrode tips. Thus, the lamp of the invention is very well suited to be used for projection purposes, e.g. for the projection of images created by a liquid crystal display (LCD) and beamers. The lamp according to the invention may further very suitably be used in projection TV and home cinema, because to its improved color spectrum.

In a preferred practical realization of the lamp according to the invention, the distance d between the electrode tips ranges from 0.3 to 0.8 mm, more preferably from 0.3 to 0.6 mm, thus further approaching a point light source. Thanks to the shorter arc, smaller LCD screens and simpler optical systems can be used, which contributes to the cost saving aspects of the lamp according to the present invention.

According to a further advantageous embodiment of the present invention, the mercury density in the vessel ranges from 0.3 to 0.8 mg/mm³, more preferably from 0.4 to 0.7 mg/mm³. The cold spot temperature in the lamp vessel is preferably in the range of 1200-1500 K in order to obtain the high mercury pressures of the lamp according to the invention, which depends on both the mercury density and the cold spot temperature. A cold spot temperature of at least 1250 K achieves that all filled mercury is evaporated, i.e. an unsaturated mercury pressure is obtained.

In a suitable embodiment of the invention, the lamp vessel comprises a bulging section enclosing the discharge space and communicating with at least two lead-through channels having a diameter smaller than the bulging section, wherein the electrical lead-through elements are closely fitted. An overheated area is prevented in the lamp according to this embodiment. Moreover, the temperature gradient in the lamp vessel and thus the thermal stress is small, and the lead-through section has little impact on the lamp vessel.

Advantageously, the bulging section is cylindrical over the distance d and has a cross-sectional diameter Di ranging from 1.5 to 4.5 mm and a length L ranging from 4 to 8 mm.

Lamps having a power in the range of 30 to 150 W have been tested, but the lamp according to the invention is expected to be able to operate also at higher powers. However, the wall load on the inside of the vessel preferably ranges from 40 to 150 W/cm² during operation. The outer wall load will be approximately 20 to 80 W/cm² then.

In the context of the present application, the term ceramic material is understood to relate to metal oxides, such as sub-micro polycrystalline aluminum (PCA), yttrium aluminum garnet (YAG), Y₂O₃, MgAl₂O₄, as well as metal nitrides, for example aluminum nitride (AlN).

The lamp according to the present invention is designed for direct coupling of power into the discharge vessel by DC/AC discharge by means of the electrical lead-through elements that extend from the electrodes to the exterior of the discharge vessel. Moreover, the lamp of the present invention allows for filling the discharge vessel with mercury and a buffer gas first, and then sealing the vessel with frit glass (i.e. a mixture of glass and crystals), filling the space between the feed-through and the vessel.

The electrical lead-through elements may each comprise a respective part which is highly resistant to halides, for example molybdenum. Niobium may be used, for example, as an external conductor in view of its favorable coefficient of expansion. The electrodes may be formed, for example, of tungsten.

The discharge medium of the lamp according to the invention comprises, for example, mercury and a buffer gas comprising, for example, argon or xenon. In addition, the high-pressure discharge lamp according to the invention preferably contains a small quantity of at least one of the halogens chlorine, bromine or iodine as a measure to avoid wall blackening by tungsten evaporated from the electrodes. These halogens create a tungsten transport cycle by which the evaporated tungsten is transported back to the electrodes.

Preferably, the halogen used is bromide in the lamp according to the invention.

The lamp of the invention may be used for several types of lighting apparatuses, such as headlights for cars and image projection apparatuses. Accordingly, the invention further relates to a lighting apparatus comprising a main body and at least a lamp as described above.

The present invention will be further illustrated by the embodiments described below with reference to the accompanying Figure.

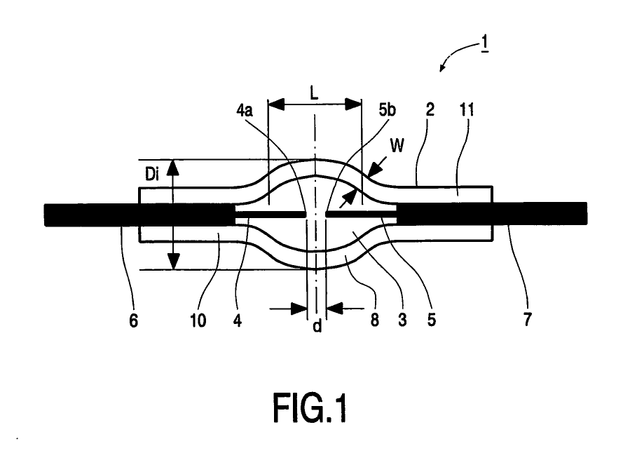

FIG. 1 is a schematic view of the lamp according to the present invention.

FIG. 1 shows a schematic view of a high-pressure discharge lamp 1 comprising a lamp vessel 2 made of a transparent ceramic material with a wall thickness w enclosing a discharge space 3, that contains an ionizable discharge medium comprising, for example, mercury and a suitable buffer gas. Within the discharge space 3 a pair of electrodes, 4,5 is arranged, which face each other and are provided with electrode tips 4a,5a at a mutual distance d, between which a discharge extends when the lamp is in operation. The electrodes are connected to electrical lead-through elements 6,7 which extend to the exterior. According to the embodiment as shown in FIG. 1, the lamp vessel 2 has a bulging section 8 enclosing the discharge space 3, which section is cylindrical at least over the distance d and has a cross-sectional diameter Di.

As shown in FIG. 1, the lamp vessel 2 has a ceramic wall and is formed of a one-piece bulging section 8 with a cross-sectional diameter Di and a length L, and elongated lead-through channels, 10, 11 in which the lead-trough elements 6,7 are closely fitted. The ceramic material is transparent at least in the area of the discharge space 3. The electrode tips are spaced apart at a mutual distance d, which in a practical realization of the invention ranges from 0.3 to 0.8 mm.

A suitable gastight connection between the lead-through element and the channel wall of the lead-through channel is formed, for example, by a ceramic glass comprising Al, Si and Dy oxides.

The lamp according to the invention may also be surrounded by a gas-filled outer envelope (not shown).

### EXAMPLES

### Example 1

In a further experiment, 8 lamps were made with a YAG lamp vessel with a diameter Di of 3.4 mm, a length L of 6 mm, and wall thickness of 0.7 mm. The distance d between the electrode tips was 0.5-0.6 mm. The burner was filled with 0.6 mg/mm³ mercury and reached 50 W, with an estimated pressure of 60 Mpa (600 bar). All lamps worked well and no explosions were observed after 10 switching operations.

EXAMPLE 2
A lamp with the following characteristics was made:

| | |
|---|---|
| Material: | YAG |
| Discharge medium: | 0.4 mg/mm³ Hg |
| Diameter Di: | 3.6 mm |
| Wall thickness: | 0.5 mm |
| Length L: | 7.0 mm |
| Distance d: | 0.8 mm |

With this lamp, burning in vertical position, a working pressure of 41 Mpa was reached, with a power of 50 W, voltage of 105 V, and current of 0.15 A.

1. High-pressure mercury vapor discharge lamp (1) comprising a lamp vessel (2) made of a transparent ceramic material, enclosing a discharge space (3) comprising an ionizable discharge medium and at least two electrodes (4,5), each provided with an electrode tip (4a, 5a), which tips are spaced apart at a mutual distance d, and electrical feed-through elements (6,7) which extend from the electrodes (4,5) to the exterior, characterized in that the distance d between the electrode tips (4a,5a) is less than 1.0 mm and the mercury density in the vessel (2) is higher than 0.3 mg/mm

2. Lamp as claimed in claim 1, characterized in that the distance between the electrode tips (4a,5a) ranges from 0.3 to 0.8 mm.

3. Lamp as claimed in claim 1 or 2, characterized in that the distance between the electrode tips (4a,5a) ranges from 0.3 to 0.6 mm.

4. Lamp as claimed in claim 1, characterized in that the mercury density in the vessel (2) ranges from 0.3 to 0.8 mg/mm³.

5. Lamp as claimed in claim 1, characterized in that the mercury density in the vessel (2) range from 0.4 to 0.7 mg/mm³.

6. Lamp as claimed in claim 1, characterized in that the lamp vessel (2) comprises a bulging section (8) communicating with at least two feed-through channels (10,11) having an inner diameter smaller than the bulging section (8).

7. Lamp as claimed in claim 6, characterized in that the bulging section (8) is substantially cylindrical over the distance d and has an internal cross-sectional diameter Di ranging from 1.5 to 4.5 mm and a length L ranging from 4 to 8 mm.

8. Lamp as claimed in claim 6, characterized in that the wall load on the inside of the vessel (2) during operation ranges from 40 to 150 W/cm².

9. Lamp as claimed in claim 1, characterized in that the ceramic material is chosen from the group consisting of sub-micro polycrystalline aluminum (PCA), yttrium aluminum garnet (YAG), Y₂O₃, MgAl₂O₄, and aluminum nitride (AIN).

10. Lighting apparatus, comprising a main body and at least a lamp as described in claim 1.
